(19) United States
(12) Patent Application Publication
(10) Pub. No.: US 2010/0037313 A1
(43) Pub. Date: Feb. 11, 2010

(54) Identification and Authentication using Public Templates and Private Patterns

(76) Inventor: Thomas Joseph Tomeny, Frisco, TX (US)

Correspondence Address: SLATER & MATSIL, L.L.P., 17950 PRESTON RD, SUITE 1000, DALLAS, TX, 75252-5793, US

(21) Appl. No.: 12/576,667

(22) Filed: Oct. 9, 2009

Related U.S. Application Data
(63) Continuation of application No. PCT/US2008/059606, filed on Apr. 8, 2008.
(60) Provisional application No. 60/922,669, filed on Apr. 10, 2007.
(60) Provisional application No. 61/005,138, filed on Dec. 3, 2007.
(60) Provisional application No. 61/007,039, filed on Dec. 10, 2007.

(51) Int. Cl. G06F 12/14

(52) U.S. Cl. 726/19

(57) ABSTRACT

A system and method for providing access by a user to a secured area is provided. Access is provided after a user performs predetermined actions on a pre-selected template. The templates, in an embodiment, may include graphical, audio, and other elements and the actions may include the performance of one or more acts, such as clicking, double-clicking, or tracing a feature, on the graphical images or interacting other ways. The sequence of template elements may be dependent upon the actions taken on one or more preceding template elements. If the path and actions taken by the user match a predetermined set of paths and actions, then the user is allowed access to the secured area.

This application is a continuation of International Application No. PCT/US2008/059606, filed Apr. 8, 2008, entitled Identification and Authentication using Public Templates and Private Patterns, which application claims the benefit of U.S. Provisional Application No. 60/922,669, filed on Apr. 10, 2007, entitled Identification and Authentication Using Public Templates and Private Patterns; U.S. Provisional Application No. 61/005,138, filed on Dec. 3, 2007, entitled Identification and Authentication Using Public Templates and Private Patterns; and U.S. Provisional Application No. 61/007,039, filed on Dec. 10, 2007, entitled Identification and Authentication Using Public Templates and Private Patterns, which applications are hereby incorporated herein by reference.

### TECHNICAL FIELD

The present invention relates generally to security systems and, in particular, to systems and methods for user identification and authentication.

### BACKGROUND

Conventional identification and authentication systems attempt to ensure that only authorized personnel or users are given access to certain computer systems, secured physical locations, sensitive records, databases, and the like.

As an example, when attempting to log on to a network, a user will typically use a conventional alphanumeric keyboard to type in their personal identification number or user name. The network will then prompt the user to enter their associated password using the same standard alphanumeric keyboard. If the password entered by the user matches the password associated with the personal identification number or user name, the user is considered authenticated and then the user is provided access to the network in a predetermined manner. This model of identification and authentication follows what may be described as the command-line paradigm. Some conventional systems require an additional step beyond the entering of a user name and password. For example, some systems require that the user identify some predetermined picture or enter yet another password or answer a security question. These conventional systems offer limited security and may easily be discovered by others using coercion, key stroke analyzing software, phishing, etc. Some newer systems use a graphical paradigm where users must memorize and/or categorize images. While these graphical systems may be superior to the command-line paradigm, they still are limited in their symbol libraries and place-value schemas, and often impose a significant thinking burden on the user.

Other conventional systems employ similar schemes which instead of or in addition to a user name and/or password, the user provides a unique identifier. For example, some conventional systems will allow access to protected areas by employing items that are carried by the user, fingerprint analysis, retinal eye scans or facial recognition techniques. Conventional identification and authentication systems may also make use of other biometric data and related user identifications (IDs) and password schemes. Ultimately, however, a person under duress may be forced to provide such identifiers at the request of an unauthorized person.

Accordingly, conventional systems generally employ authentication methodologies that make use of a limited set of data, symbols, and place value schemas. Thus, conventional systems limit the number of possible IDs and combinations of IDs and passwords while often putting a significant burden on users to possess and know things. Conventional systems, therefore, fail to provide adequate security.

There is therefore a need for improved systems and methods for user authentication and identification.

### SUMMARY OF THE INVENTION

This invention relates to a method and system of identification and authentication using the exchange of patterns in a path and action paradigm.

In an embodiment, a method of identifying and authenticating a user of a secured area is provided. The method could include a gateway to the secured area transmitting a publicly-known template with known navigation rules to the user upon a user's initial request. As the user navigates the template and performs various patterned actions within the template, the gateway logs and analyzes those steps and actions in order to seamlessly identify and authenticate the user. As the gateway transmits its template the user observes the known template and its adherence to the known navigation rules to authenticate the gateway. The method could further include the transmission to the user of one or more acceptance patterns that are customized per each user and one or more acceptance actions that the user performs in order to accept the gateway as authentic before using the gateway to transmit any sensitive data. The user's actions may encompass an infinite variety of possibilities with the provided template.

In another embodiment, a system for identifying and authenticating a user authorized to use a secured area is provided. The system could include a circuit configured to receive actions associated with a user identity and authentication.

Other technical features may be readily apparent to one skilled in the art from the following figures, descriptions and claims.

### BRIEF DESCRIPTION OF THE DRAWINGS

For a more complete understanding of this invention and its features, reference is now made to the following description, taken in conjunction with the accompanying drawings, in which:

FIGS. 1A-1C illustrate exemplary scenarios in which a pattern exchange occurs between a user and a receiver to gain access to a secured area according to an embodiment of the present invention;

FIG. 2 illustrates an exemplary system receiver and display unit according to an embodiment of the present invention;

FIG. 3 is a flow diagram illustrating a method according to an embodiment of the present invention;

FIG. 4 is a flow diagram illustrating a method according to an embodiment of the present invention; and

FIGS. 5A-5G are example screen shots of a login sequence in accordance with an embodiment of the present invention.

### DETAILED DESCRIPTION OF ILLUSTRATIVE EMBODIMENTS

The present invention provides an identification and authentication system and method. In an embodiment, the present invention provides a virtually unlimited number of symbols and place value schemas to use in identifying and authenticating an authorized user of a desired system. An unlimited number of templates can each accommodate a virtually limitless number of combinations of patterned actions that each are analogous to a symbol and place value schema. In addition, an embodiment of the present invention generally provides a system and method for combining the identification and authentication of an authorized user of a secured area into an integrated, continuous and efficient system. For example, in an embodiment, the present invention provides a simplified method in which patterns of behavior or actions which could already be a part of a particular user's life experience could be used to authenticate the identity of the user, making the process considerably easier for the user than other methods.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise

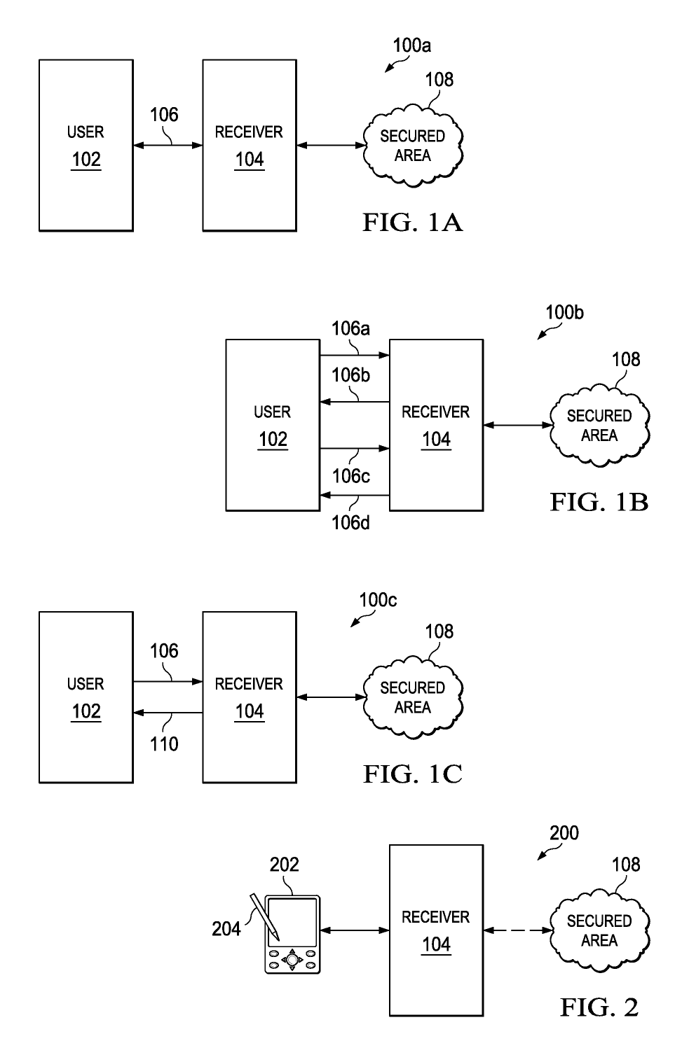

Referring first to FIG. 1A, system 100a provides a system of identifying and authenticating a user 102 and a receiver 104 using a pattern exchange 106 according to an embodiment of the present invention. For example, a pattern exchange 106, or series of pattern exchanges, occurs between user 102 and receiver 104 establishing an identification and authentication routine. Pattern exchange 106 may be any suitable pattern exchange as later described herein.

Pattern exchange 106 is preferably initiated by user 102 after some action, but in some embodiments may be initiated by receiver 104. In either case, user 102 may be attempting to gain access to secured area 108 (or multiple secured areas). For example, secured area 108 may be any area such as, for example, certain computer systems, certain areas of computer systems, secured physical locations, sensitive records, databases, and the like. It should be understood that secured area 108, in the context of computer systems, may be characterized as having any suitable architecture, for example, a client-server architecture, a peer-to-peer architecture or any suitable combination thereof according to an embodiment of the present invention.

On the other hand, receiver 104 may be any suitable access point such as, for example, a computer terminal, access terminal, keypad, cell phone, or any other accessing device that may aid in authenticating the identity of user 102. For example, receiver 104 may be a gateway or specific access point associated with secured area 108. In other words, receiver 104 may be a gateway or access point to a computer system, a gateway to a web site, a gateway to a network, a gateway to the Internet, a secured physical location, sensitive records, databases, and/or other areas to which user 102 seeks access. Additionally, receiver 104 may be a common access point such as, for example, a video display, computer terminal, a microphone, or a pointing device, configured to serve a number of different secured areas 108. Additionally, receiver 104 may be a network element, such as a server, on a network.

Regardless of the specific mechanism employed by receiver 104 at a given access point, user 102 and receiver 104 present a pattern to the other according to one embodiment of the present invention. User 102 and receiver 104 each, in turn, respond by presenting an identification and authentication pattern to the other. Thus, pattern exchange 106 is formed.

In the case of receiver 104, the pattern presented may be publicly known and respond to publicly known navigation rules, this set of patterns and rules is known hereinafter as a public template. Each user of receiver 104, including user 102, has a unique and private set of actions and navigations that are taken within the public template. Receiver 104 may additionally have a wide variety of public templates it may offer to its users, and each user may be presented with a different public template.

FIG. 1B illustrates system 100b including an exemplary pattern exchange 106 after user 102 has requested and received the starting template from receiver 104. For example, user 102 provides first pattern 106a to receiver 104. In response, receiver 104 provides template pattern 106b. User 102 then provides third pattern 106c. In response to third pattern 106c, receiver 104 provides user 102 with template pattern 106d. First pattern 106a, second template pattern 106b, third pattern 106c and fourth template pattern 106d are sometimes collectively referred to herein as pattern exchange 106. The process continues until a predetermined or predefined pattern exchange 106, or series of pattern exchanges, occurs between user 102 and receiver 104 that establishes the identification and authentication of user 102 as an authorized user of secured area 108.

Receiver 104 logs and analyzes the patterns presented by user 102 in an attempt to match the overall pattern exchange with that of a known user. After pattern exchange 106 is sufficiently correlated by receiver 104 and the identity of user 102 is established by receiver 104 and user 102 is satisfied that receiver 104 is indeed authentic, user 102 could access secured area 108.

If, on the other hand, the elements or data within pattern exchange 106 does not contain appropriate identifying and/or authenticating elements, user 102 may be denied access to secured area 108 until a time in which receiver 104 (or, alternatively, user 102) begins the process again. After some predetermined limit to the number of failed attempts in recognizing pattern exchange 106, receiver 104 may temporarily or, in some cases, permanently block access to secured area 108 from the device where the failed attempts occurred. Receiver 104 may also notify the appropriate authorities of such an attempted security breach. Similarly, if user 102 is presented with template patterns and an acceptance pattern that are not appropriate, the user could discontinue attempts from that physical or virtual location and notify the appropriate authorities. If the receiver presents an acceptance pattern and does not get the correct response from the user, the receiver may lock out that user's access while it investigates the possibility that a user's pattern exchange may have been compromised.

In an embodiment, after authentication, receiver 104 may present acceptance pattern 110 to user 102 as illustrated by system 100c shown in FIG. 1C. Acceptance pattern 110 authenticates receiver 104 (and hence any access points associated with receiver 104) to user 102. For example, in an embodiment, receiver 104 may in fact not represent the desired secured area 108. In order to avoid any fraudulent or counterfeit receivers 104, receiver 104 may be required to provide acceptance pattern 110 to user 102 before providing user 102 access to the desired secured area 108. Thus, receiver 104 presents acceptance pattern 110 and user 102 may identify acceptance pattern 110 as indeed the correct acceptance pattern 110 associated with secured area 108. Thus, acceptance pattern 110 serves as an extra precaution before user 102 begins to access secured area 108. If receiver 104's public templates were duplicated for the purpose of fraud, the lack of the correct private acceptance pattern would prevent the user from continuing to use the system with sensitive information. Similar to pattern exchange 106, acceptance pattern 110 may be any suitable pattern as later described herein. In some applications, acceptance pattern 110 may not be used, for instance if the device and access area are in a secure non-networked environment.

If, for example, user 102 does not identify acceptance pattern 110 as being associated with secured area 108, user 102 may ascertain that secured area 108 or receiver 104 is fraudulent, counterfeit or that there may be some sort of security breach. At that time, user 102 may decide to terminate the process and/or notify the appropriate authorities of the breach. Systems 100a, 100b and 100c are sometimes collectively referred to herein as system 100.

Referring now to FIG. 2, system 200 provides a user, such as user 102 in FIGS. 1A, 1B and 1C, access to secured area 108 such as, for example, an information network that includes receiver 104. Receiver 104, in this example, may be a server on the information network and may be associated with user device 202. User device 202 allows user 102 to input data such as, for example, pattern exchange 106, with a pointing device 204 according to one embodiment of the present invention. It should be understood that pointing device 204 is optional and that user 102 may use their finger, keypad, function keys, or the like to input data. For example, user device 202 may be a touch enabled screen or other similar device.

User 102 may input an initial pattern, such as exchange 106 described in conjunction with FIG. 1A herein, by navigating a web page or a series of web pages. Once at a desired web page, the user may manipulate pointing device 204 (or other input device) to perform an action with respect to an object, such as selecting an object on the web page displayed on user device 202. Receiver 104 logs the movements, clicks, and other information of pointing device 204 (or other input device), and any subsequent actions on user device 202 both in an absolute manner and relatively to the existing displayed pattern and its various attributes. The receiver 104, in turn, then displays the next template pattern based upon the activity of user 102 and the chosen template and template navigation rules.

User 102 and receiver 104 exchange patterns in this manner until receiver 104 detects the appropriate data to identify the user. In this example, the pattern will be a series of points or clicks on web pages. After detecting the user's identity, receiver 104 compares stored data with any activity prior to establishing the user's identity being established in order to authenticate that the pattern and/or attributes were provided following an appropriate sequence or collection of data points and/or attributes.

In one embodiment, pattern exchange 106 may be a single exchange. For example, a map may be displayed by receiver 104 and user 102 may only need to click on a specific location on the displayed map to complete pattern exchange 106. A single exchange without an acceptance pattern may be desirable in a very low security context, such as low as monitoring who is going into the home refrigerator.

Preferably, access is granted by receiver 104 only if the identity of user 102 is authenticated. Some of the actions, patterns, data points and/or attributes received may be superfluous. For example, superfluous actions or data points may serve to hide the “real” authenticating signal or signals within a certain threshold if an observer is present.

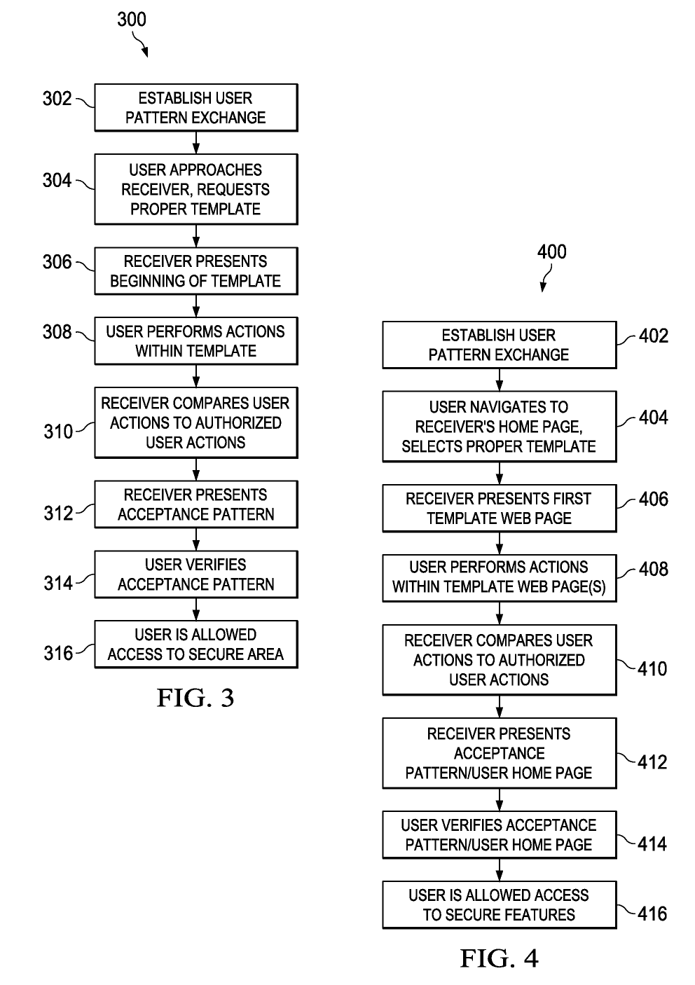

FIG. 3 is an exemplary method 300 for identifying user 102. As an example, user 102 may have established at some time a pattern exchange, such as pattern exchange 106, to use to identify itself in step 302. Once pattern exchange 106 has been established, user 102 need not repeat step 302 unless, of course, there is a specific need requiring a change or alteration of pattern exchange 106 such as, for example, system upgrades or a desire for a more complicated or different pattern exchange 106. A user's pattern exchange will generally be based upon using one of a receiver's templates.

In step 304, if user 102 desires to access a secured area, such as secured area 108, user 102 accesses an access point or receiver for secured area 108 such as, for example, receiver 104. User 102 performs a first action to request the desired template from receiver 104. In step 306, receiver 104 transmits the initial pattern of the desired public template. In step 308 user 102 performs actions on the template that is observed by the receiver 104. In step 310, receiver 104 attempts to match user 102's cumulative actions against its file of identification and authentication patterns of authorized users. If user 104 is determined to be an authorized user, receiver 104 then provides user 102 with the acceptance pattern 110 in step 312. In step 314, user 102 observes acceptance pattern 110 and, if satisfactory, performs final verification action or actions. Acceptance pattern 110 may have multiple parts like the identification and authentication patterns in order to safeguard against phishing by sites that will not know the customized acceptance pattern for each user. In step 316, user 102 gains access to the secured area.

Unless a pattern exchange consists of only one action in step 308, none of user 102 actions in step 308 constitutes a single key to user 102's identity. Identity is determined by receiver 104 based upon an infinitely variable specification agreed to by the user when the pattern exchange is established. A pattern exchange could involve various types of actions and could include their sequence, the timing between them, and other variables. Receiver 104 only identifies and authenticates users after a complete match on the pattern exchange with a known authorized user, including the acceptance patterns. Accordingly, method 300 seamlessly identifies and authenticates user 102 while allowing for an infinite combination of different pattern exchanges among all users.

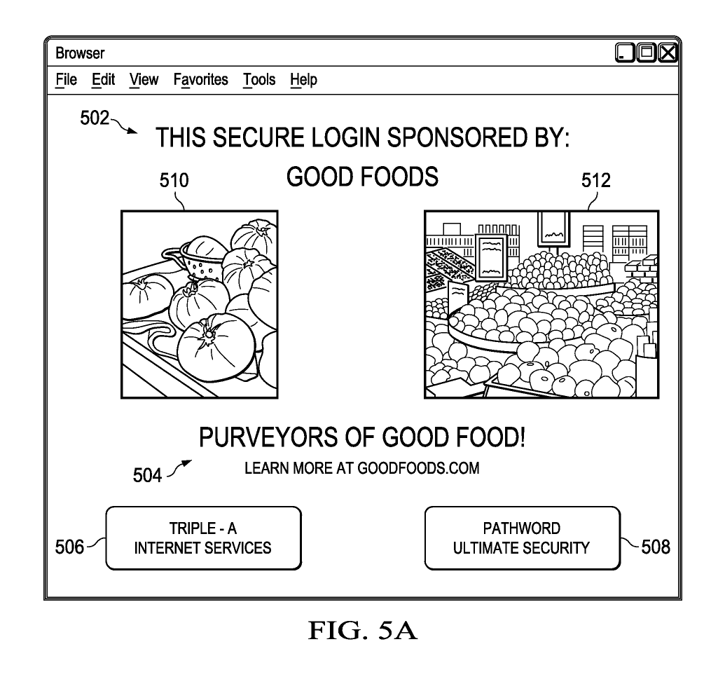

FIG. 4 is another embodiment of a method 400 for identifying user 102. As an example, user 102 may have established at some time a pattern exchange, such as pattern exchange 106, to use to identify a particular user in step 402. Once pattern exchange 106 has been established, user 102 need not repeat step 402 unless, of course, there is a specific need requiring a change or alteration of pattern exchange 106.

Pattern exchange 106 may include, for example, a three-point pattern associated with web pages accessed from an Internet, Intranet or some other suitable system. After requesting a template start page associated with the receiver 104 in step 404, the user may provide pattern exchange 106 within the template web page(s) in step 408. For example, the user may click on, select or otherwise perform some sort of action associated with a first enabling point A on a first template web page. The user may then click on, select or otherwise perform some sort of action associated with a second enabling point B on the same template web page or a second template web page. Finally, the user may click on, select or otherwise perform some sort of action associated with a third point C on either the first, the second or other template web page. The action may be a context-based action, such as performing an action on any blue object, rather than performing an action on a particular type of object. Although a three-point pattern has been described herein, it should be understood that any number of points may be included in pattern exchange 106 in accordance with the present invention.

Now referring to FIG. 4, in step 404, if user 102 desires to access a secured area, such as secured area 108, user 102 approaches an access point, receiver, or start page associated with secured area 108 such as, for example, receiver 104. Receiver 104 presents the first template web page to user 102 in step 406. User 102 then takes the actions on the template web pages according to the predetermined pattern exchange 106 in step 408. In step 410, receiver 104 confirms that user 102 is indeed an authorized user and has provided the correct pattern exchange 106. Receiver 104 then provides user 102 with acceptance pattern 110 in step 412 that may also serve as the user's customized starting place for the access granted. In step 414, user 102 observes acceptance pattern 110 and, if satisfactory, performs the acceptance action or actions and gains access to secured area 108. If the acceptance pattern 110 is not also the user's appropriate starting place for the access granted, the user may perform an additional verification action of the acceptance pattern and be directed to the appropriate starting place for the access granted. The acceptance portion of the pattern exchange differs from the rest of the pattern exchange in that it is only provided to the user after the receiver has identified and authenticated the user using the earlier portions of the pattern exchange. Accordingly, using the steps in FIG. 4, method 400 seamlessly identifies and authenticates user 102.

In one embodiment, method 400 could include pattern exchange 106 with various predetermined actions using zoomable satellite pictures of the Earth. User 102 could request a template start page that displays a satellite picture of the Earth that is slowly rotating. User 102 could alter the vantage point and perform a series of specific action included in pattern exchange 106.

Suppose that user 102 has double-clicked on an area of the Mississippi delta as required by pattern exchange 106 and that double-clicking is also a template rule for zooming in. Moreover, suppose that pattern exchange 106 requires an element that the user 102 double-clicks on the Mississippi delta just as it appears on the horizon of the rotating satellite picture. In response, receiver 104 and/or an associated server checks this action against a master list of pattern exchanges and could, for example, narrow the identities of possible users to just 200 out of 500,000 template users who use this particular action as their first step in their personal pattern exchange 106. Not only does receiver 104 log that user 102 double-clicks on the Mississippi delta, but also when and how user 102 clicks on the Mississippi delta (e.g., did user 102 double click on the Mississippi delta as it appeared on the horizon of the spinning satellite picture?) Accordingly, the actions may be context sensitive.

After logging the action by user 102, receiver 104 will in response stop the rotation of the satellite picture and zoom into the area surrounding the Mississippi delta as per the navigation rules of this template.

User 102 could then trace (using any pointing device or finger) the now clearly visible Lake Pontchatrain causeway from north to south. At this point, receiver 104 could examine this action and determine that no other users on the master list who have not been eliminated in the previous step have this same action in their respective pattern exchanges. But this is not yet a complete pattern exchange for user 102 so receiver 104 does not yet present the acceptance pattern.

Continuing with this example, user 102 could then double-click on the French Quarter area of the City of New Orleans and in response to the template navigation rules receiver 104 zooms in on the French Quarter/Downtown New Orleans. Then, user 102 clicks on any ship that is visible in the Mississippi River. After all the components of the pattern exchange have been performed, user 102 is presented an acceptance pattern which may also work as an appropriate starting place for the access granted to user 102 by receiver 104. The appropriate starting place for the access granted may contain user designated icons and other features and the various alarm features may be activated by certain actions on this page or other pages. Such a pattern of action is difficult, if not impossible, for a bystander to correctly observe user 102 and learn the actions required by pattern exchange 106, especially since user 102 may be performing other superfluous actions simultaneously and some or all of the actions may be context based rather than location based.

Now, suppose that pattern exchange 106 only included: (1) a double click on Mississippi Delta region when it became visible on horizon; (2) a trace from north to south on the Lake Pontchartrain causeway; (3) a double-click anywhere within French Quarter; and (4) a single click on any ship in the Mississippi River. In response to each element of the pattern exchange 106, receiver 104 would respond according to the template navigation rules while logging the user's actions. Receiver 104 had already established an identity when element 2 above was complete. Elements 3 and 4 were simply authenticating patterns to ensure that a random user had not happened upon elements 1 and 2. Accordingly, embodiments of method 400 seamlessly identify and authenticate user 102. Each user could have their own pattern of actions within a template environment that is personally memorable. The seamlessness of the process compared to existing identification and authentication methods is that these pattern exchange actions are continuous in the transition from identification to authentication, there is not one set of identification actions and a separate set or sets of authentication actions. After the receiver identifies a user, it may look back upon previous actions to search for additional authentication actions. The receiver may change the navigation rules as soon as a user has been identified, causing a departure from the public template. If the user does not see that change from the public template, the user will not be able to respond appropriately, and that will decrease the chance that phishing attacks are successful.

The transition from identification to authentication to acceptance may be seamless to the user, as there may or may not be any categorical difference between the public and private parts of the template, other than being public or private. For example, using the zoomable map style template. Lower zoom levels may be a part of the public template while the close up zoom in levels may actually only be available to a specific user as part of their acceptance pattern.

Referring now to methods 300 and 400, it should be understood that user 102 may have in fact included any number of superfluous actions or patterns while performing pattern exchange 106. For example, suppose that pattern exchange 106 requires three actions. User 102, however, may in fact perform four actions such as, for example, point A on a first template web page, point B on a second template web page, point X on the third template web page, and then point C on a third template web page. Thus, when user 102 enabled point X on the third template web page, it would essentially be ignored by receiver 104 and considered “superfluous” and entered only for hiding the correct exchange pattern 106. Similarly, although a four point “superfluous” pattern has been described herein, it should be understood that any number of points may be used in a “superfluous” pattern in accordance with the present invention. Also, a pattern exchange could include one or many random actions specified in a sequence between non-random actions.

Context rather than location based actions allow users to take actions that appear different to observers but actually send the desired pattern to a receiver. For instance, during one pattern exchange a user might click on Lake Michigan and during a subsequent pattern exchange the same user might click on the Atlantic Ocean. If the specification of the action is clicking on a different body of water than used during the last successful attempt, both actions satisfy the pattern exchange but appear different to an observer. An observer trying to decode and steal a user's identification and authentication pattern based upon even multiple observations would have additional difficulties if these context based actions are utilized and employed differently in different attempts. Similarly, an infinite number of context based actions that change absolutely or relatively in some sort of sequence may form valid actions within a pattern exchange.

User pattern actions may be arbitrarily simple or complex as per the agreed upon pattern exchange. For example, a simple action may be single clicking on a location or answering a phone call. An example of a more complex action may be drawing a closed loop around three particular elements in a template but leaving two other elements outside the loop, which would make it very difficult for an observer to know which elements were important to the pattern, particularly if the location of the elements changes each time the template is presented. Another type of complex action may involve using a certain time sequence between other actions. All of these complex actions are within the scope of this invention.

Optionally, during and/or after methods 300 and 400, user 102 may perform any number of predefined alarm patterns according to an embodiment of the present invention. For example, during or after methods 300 and 400, user 102 (or receiver 104) may initiate a predefined alarm pattern. As one example, if user 102 was being forced to exchange patterns with receiver 104 at gunpoint, user 102 could enter an alarm pattern directing receiver 104 to notify the appropriate authorities without the gunman knowing it. In fact, the gunman could observe the alarm pattern and believe that it was just part of a routine operation or a part of the requested operation. As another example, if user 102 was being forced by the authorities to exchange patterns, another predefined alarm pattern could direct receiver 104 to send out a mass predefined email to the appropriate human rights groups or individuals.

In other embodiments, alarm patterns may cause receiver 104 to ignore the session completely. As an example, user 102 may appear to direct the contents of their bank account into an assailant's account. However, because user 102 may have entered an alarm code, nothing is transacted though it may be displayed as such. Likewise, receiver 104 may display certain predefined alarm patterns to user 102 to notify user 102 of any security situations on the part of receiver 104. Such alarm patterns may be displayed overtly or in a confidential manner to which only user 102 would understand.

In an embodiment, user 102 may provide a predetermined alarm pattern requesting a noisy template from receiver 104. For example, the pattern may specify a noise factor or allowance to control how much, if any, noise in the form of superfluous template objects should be generated by receiver 104 as it presents template patterns in order to deceive possible observers. Receiver 104 may retain any data collected during identification and authentication attempts.

In an embodiment, system 100 or system 200 may be used to gain access to an information network using noise or speech for example, via speakers, microphones, telephones, cell phones, and other voice conveying instruments. In addition, voice recognition techniques may also be used according to one embodiment of the present invention.

In one embodiment, user 102 may call an access number using a telephone or other communication device. The communication device may play, for example, a predefined template song or other template audio pattern. At a predefined place, set of places within the song or after a specific audio pattern, user 102 may say a predefined word or set of words(s). As another example, user 102 may perform a recognizable action like pressing a certain button or series of buttons. Then system 100 or system 200 may continue playing the same template song, play a second template song or template audio pattern and user 102 would again wait for the appropriate point or points and say another word or group of words or take another system recognizable action. This sequence would continue until system 100 or 200 identifies user 102. Similar to other embodiments, the telephone or other communication system would continuously analyze the data collected during the process to identify and authenticate the user based upon that data.

In some embodiments, system 100 or system 200 may use tactile data to access secured area 108. A deaf, mute, blind or other user could approach display board of electromechanically elevated pegs. User 102 would reconfigure the pegs to request the initial template pattern. After system 100 or 200 detects the user's request, it would respond with its own subsequent template pattern. This exchange then continues until both the user and the system have identified and authenticated each other. A more common use of the tactile data embodiment may be using different degrees of pressure on the pointing device or finger when exchanging patterns on a visual display.

In an embodiment, user 102 may use a combination of devices for entering or receiving pattern elements. The pattern exchange may start with an interaction on a video device such as a computer screen and continue on another device such as a telephone. For instance, the authentication pattern may begin with or include a call being sent to the user's phone and the user may need to respond in a certain manner such as answering within a specified time, saying a certain phrase, or pressing the appropriate keys. There is no limit to the number and type of devices that may be part of the pattern exchange or their order in the pattern exchange. In the computer screen and telephone example the user's appropriate starting place for the access granted could appear on the computer video after the telephone portion of the exchange has concluded. A public template may include utilization of multiple devices, which allows use of multiple devices before identification and authentication is achieved by the receiver. Furthermore devices may operate in multiple modes during the pattern exchange, for instance, video and sound inputs may be used on a device in addition to pointing and clicking or other pressure and position sensitive inputs. In certain applications, some actions may be performed without devices. For instance, when the secured area is a physical space, part of the pattern exchange may involve a live interaction with a security guard.

Other embodiments may provide user 102 with other means of inputting data for pattern exchange 106. For example, user 102 may use other senses and various combinations of the senses to exchange patterns including, for example, tastes, smells, colors, sounds, sights, other tactile data and any suitable combination thereof.

It should be understood that embodiments of the present invention may be applicable to a variety of different applications besides in conjunction with conventional information network as described herein. For example, it should be understood that embodiments of the present invention may be used in conjunction with conventional systems and/or in lieu of conventional systems. This invention represents a development platform for other applications based upon this path and action pattern exchange paradigm.

It should also be understood that there are numerous applications for embodiments of the present invention such as, for example, identification and authentication requirements in conventional credit card systems, radio frequency identification (RFID) credit and smart card devices, secure access areas and gates, ticketing systems and voting systems. In addition, embodiments of the present invention may be used to complement, retrofit or replace existing systems such as, for example, physical keys and locks, physical identification badges, conventional passports, birth certificates, driver's licenses, social security cards, etc.

It should be understood that methods 300 and 400 may be performed relatively quickly and possibly in a matter of seconds. It would be very difficult for a bystander or device or software to capture the elements because the boundaries and contexts of the elements may be unconventional and the templates may be presented in slightly altered forms. In fact, in the globe example, the spinning globe may be positioned in different initial conditions and each of the template map segments will be at least slightly different every time as slightly different double click navigation points will center the resulting zoom map at different points. A user may perform some action on some object but absent the specific context of the pattern exchange, it may be very difficult for others to discover and replicate an action on an object that actually fulfills the criteria of the pattern exchange.

In many embodiments, the images and sounds employed in the patterns may have other purposes, perhaps to educate, inform, and advertise to the user. For instance, a particular receiver's start page might contain a full screen advertisement for a company that wishes to sponsor that individual identification and authentication session. If they display an ad on the start page with basic colors embodied in it like red, green, blue, and yellow (colors that could appear in all start page ads regardless of advertiser), the user might click on a particular red object within the ad to indicate that the user uses the “red” standard template from that provider. To enhance the advertising value and provide for a more convenient and shorter reentry to the secured area, the system and method include a sleep mode after a user specified period of non-use. As the user approached the sleeping logged on connection, the original ad from the original log in may be displayed. If the user selects the exact same red object within the ad displayed, the other elements of the log in may be shortened before allowing re-access. The user benefits with a shorter pattern exchange process that still enjoys high security as it involves a shared secret, namely, the particular red object selected during the initial login that is valid for that particular session only. The advertiser enjoys the benefit of having the user remember and focus on something within the ad.

Any and all of the pattern elements in any and all pattern exchanges may contain advertising messages. In some cases, users may pay a premium in order to not be shown advertising messages. The advertising messages may form an integral part of all patterns, and many of the user actions may be with the advertising messages and contextually based. On a video screen, some advertising messages may be full screen while others are smaller and arranged or used in patterns that are significant to the pattern exchange. There is no limit to the amounts and types of advertising that may be contained in a pattern exchange other than the practical limitations of the user's time and ability to distinguish messages. The use and position of advertising may be one way that the user can authenticate the receiver, both within the public template and the private acceptance patterns.

Pattern elements may include still images, animated video, live motion video, and sounds. Any method that conveys a useful pattern element is within the scope of this invention.

In another embodiment, some or all of the pattern elements may reside on the user's device rather than on a remote server. This allows the pattern elements to be displayed more quickly and may also constitute a software token, in that the pattern exchange may not be completed unless these elements/tokens are present on the user's device. It is contemplated that in some applications this software token approach may be used while in others it will not. Software tokens may also be employed that do not duplicate elements already employed in the pattern exchange.

In another embodiment, this method and system may be used to mimic but still improve older paradigms. For instance, users who insist on sticking with a system that allows them to type their user name and password may be presented with an initial screen that accepts all or part of their user name and additional screens which may comprise path and action identification and authentication in accordance with one or more embodiments of the present invention. The added security features may be that the additional patterned screens displayed to the user by the receiver may be sufficient to thwart phishing attacks and that the receiver may include non-obvious methods of authenticating the user, such as timing the user name and password entry process to make sure it is within the characteristic pattern of that user. Many pattern elements may include various keyboard actions, including typing user names and passwords, though they may be used in an unconventional way for greater security.

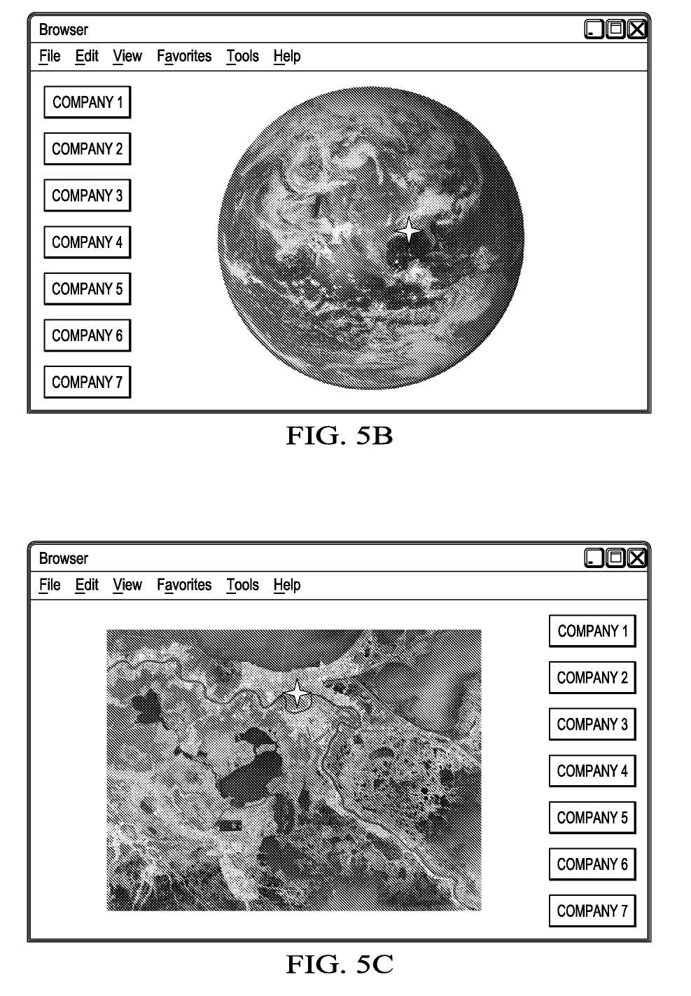

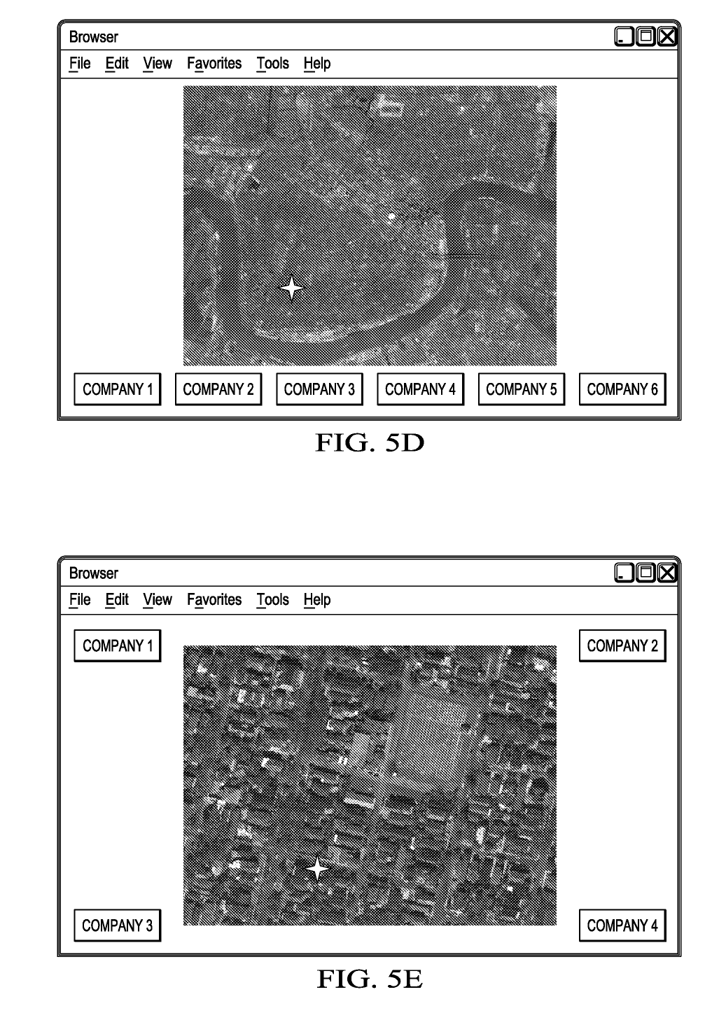

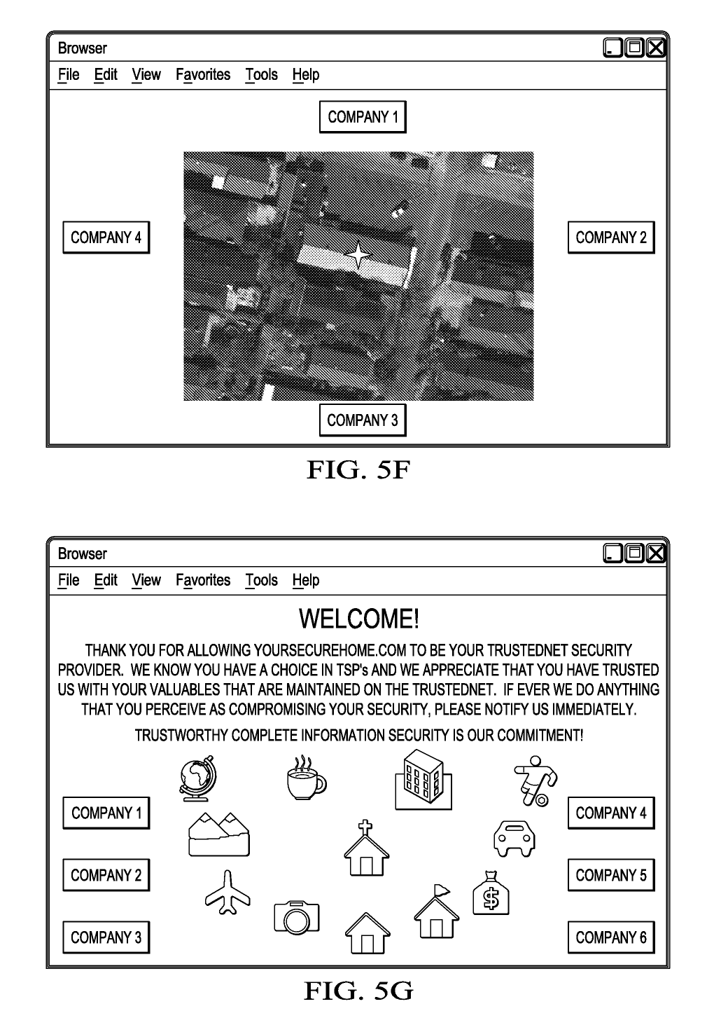

FIGS. 5A-5G are screen shots that illustrate one method of providing a secure logon system in accordance with an embodiment of the present invention. Referring first to FIG. 5A, illustrates a website that onto which the user desires access. The website may be for a specific company (such as a banking or financial institution), a service provider (such as an Internet Service Provider), a trusted network service provider, or the like. In an embodiment, the design or content of the website comprises a template chosen by the user and may be reached by entering a URL, clicking a link, requesting secure data, or the like.

As illustrated in FIG. 5A, the website may include various advertisements, such as advertisements 502 and 504, which may include links to sponsor websites. The advertisements may also include a service provider identification, such as service provider identification 506 as well as a log-in process technology indicator, such as log-in process technology indicator 508.

Also included in FIG. 5A are graphical images 510 and 512. The graphical images 510 and 512 may be chosen by the service provider based upon a template chosen by the user. In this example, the user may have chosen a blue template. Based on the blue template, the service provider may present objects, at least some of which are related to the chosen blue template. The service provider may choose to sell advertising which the user would necessarily need to examine in order to proceed.

In this example in which the user had chosen the blue template, the user would proceed by selecting something blue on the displayed web page. The blue may be, for example, blue lettering, a blue image, a blue background, a blue advertisement, or the like. Once selected, the service provider navigates the user to the beginning of the blue template.

It should be noted that colors are used for purposes of illustration only and that the templates may be distinguished by letters, locations, actions, or the like. Alternatively, some identity providers may only have one template and skip this step altogether.

FIG. 5B illustrates an example of a beginning of a blue template in accordance with an embodiment of the present invention. In an embodiment, the template operates under navigation rules, such as a double-click centers and zooms on that location and right clicking converts the cursor to the hand to push or pull the image on the screen, and the like. Preferably, other non-navigation input from the user is also tracked, including cursor movements, keyboard activity, mouse clicks, sound input, and the like. It should be noted that the templates may contain moving components or animations. In the example illustrated in FIG. 5B, the Earth may be rotating.

Also illustrated in FIG. 5B are advertisements. The advertisements may be in addition to the template, or the advertisements may be an integrated into the template, such as a Pepsi can sitting on a table or a billboard in a cityscape. The advertisements may also be an integral part of the template in that the user may be required to perform certain actions relative to the advertisements.

To proceed from this page towards identification and authentication, the user must perform a path and action sequence corresponding to a predetermined path and action sequence. For example, the user may be required to a yellow region of any advertisement and then double click successively on the Mississippi Delta in order to zoom in. The “yellow in ad” click is an example of a non-navigation action that is part of the sequence while the Mississippi Delta is an example of a navigation action which is also a part of the sequence.

FIG. 5C illustrates a zoom-in image of the Mississippi Delta in accordance with an embodiment of the present invention. In this example, the user's sequence requires him to click on any body of fresh water different from his last attempt and then perform a navigation double click on the area around the Superdome. The any different body of fresh water action adds complexity and makes it unlikely that an onlooker could duplicate the login.

Next, in FIG. 5D, a zoom-in image of the area around the Superdome is presented in accordance with an embodiment of the present invention. For a higher level of security, the web page may contain a hidden and changeable navigation rule, such as requiring the user to click on the navigation spot a number of times equal to the number of advertisements displayed. And this could actually be a private rather than public rule by this point, because the receiver has already collected enough data to identify the user.

The navigation point in this example is a cemetery on Arabella Street. The user may also perform superfluous actions and navigation anywhere within the template, as long as the required action and path is completed. Once selected, a zoom-in image such as that illustrated in FIG. 5E is presented to the user, and again, advertisements may be positioned around the image.

In an embodiment, the receiver has identified the user and may display ads custom selected for the user. The navigation point on FIG. 5E is the house across from the fire station two blocks south of the western edge of the cemetery on Arabella Street.

In an embodiment, the user may perform actions that are particularly hard to decipher. For example, the user may be required to trace a closed shape around the three roofs that does not include any part of the cemetery. For added security, the three roofs may have to be a particular color or shape.

FIG. 5F illustrates a close-up view of the house selected in accordance with an embodiment of the present invention. In this example, the chimney is the final navigation destination within the map portion of the template. For additional security, other devices may be incorporated. For example, the receiver may call the user's cell phone and require the user to respond to that call in a certain way as an extra security measure.

Finally, FIG. 5G represents a customized welcome screen containing multiple links as customized to the particular user in accordance with an embodiment of the present invention. The welcome screen may include hidden links to call the authorities or call the world in the event that the user was forced under duress to perform the login actions. Accordingly, the links on the customized welcome screen may or may not access what they appear to access to mislead unauthorized personnel. Preferably, there is at least one and possibly several actions the user must successfully complete after getting to this or other customized screen. These actions may be desirable to prevent phishing as a phisher could spoof the publicly available portions of a template but could not readily spoof the private customized elements.

Throughout this disclosure, the terms user and receiver have been used in the singular. The invention also anticipates that users may be plural and receivers may be plural. It is within the scope of this invention to use this system and method for a group of users who may be geographically distant to each perform certain actions as part of the overall pattern exchange. It is also within the scope of this invention that the receiver may involve numerous physical and virtual entities that may be geographically distant. Any combination of singular and plural users, receivers, secure areas, and other elements is within the scope of this invention.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this invention has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention, as defined by the following claims.

What is claimed is:

1. A method of providing access by a user to a secured area, the method comprising:
individually transmitting a plurality of pattern elements, each of the pattern elements comprising at least one of a graphical image and a sound;
between the individually transmitting the pattern elements, receiving an action taken by a user on a preceding pattern element, at least a portion of the action involving at least one of the graphical image or the sound of the preceding pattern element, wherein a number and a sequence of subsequent pattern elements is based at least in part on preceding actions;
comparing a sequence of the pattern elements transmitted and the actions received with a predetermined path and action sequence; and
allowing access to the secured area when the sequence of the pattern elements transmitted and the actions received match the predetermined path and action sequence.

2. The method of claim 1, further comprising selecting one of a plurality of templates, each template comprising a set of pattern elements.

3. The method of claim 1, further comprising between the individually transmitting the pattern elements, receiving one or more navigational methods used by the user to navigate the preceding pattern element, wherein the number and sequence of subsequent pattern elements is further based at least in part on the one or more navigational methods.

4. The method of claim 1, wherein the graphical image comprises a map.

5. The method of claim 4, wherein subsequent pattern elements include a modified section of the map from a previous pattern element.

6. The method of claim 1, wherein the action comprises utilizing an object on the graphical image.

7. The method of claim 1, wherein the action comprises tracing a path on the graphical image.

8. The method of claim 1, wherein the individually transmitting includes transmitting a first pattern element to a first user device and transmitting a second pattern element to a second user device, the first user device being different than the second user device.

9. The method of claim 1, wherein the pattern elements comprise one or more advertisements.

10. A method of receiving log on information, the method comprising:
(a) transmitting a first element, the first element comprising one or more first images or first sounds;
(b) receiving a first action taken by the user on the first element;
(c) determining a second element, the second element being based at least in part of the first action; and
(d) transmitting the second element, the second element comprising one or more second images or second sounds.

11. The method of claim 10, further comprising repeating steps (b)-(d) for a plurality of elements.

12. The method of claim 10, wherein the first action includes a navigational action performed on at least one feature of the one or more first images.

13. The method of claim 10, further comprising:
comparing received actions and a received path with a predetermined set of actions and a predetermined path; and
allowing access to a secured area when the received actions and the received path matches the predetermined set of actions and the predetermined path.

14. The method of claim 13, wherein the received actions include more actions than the predetermined set of actions.

15. A network element for providing access by a user to a secured area, the network element comprising:
a first communications connection;
a second communications connection to the secured area; and
a receiver configured to transmit a plurality of elements and to receive a plurality of paths and actions over the first communications connection, and to allow access to the secured area if the paths and actions match a predetermined set of paths and actions, at least one of the actions including a first action on one or more graphical images.

16. The network element of claim 15, wherein the plurality of elements is selected from one of a plurality of public templates.

17. The network element of claim 15, wherein a sequence of elements is based at least in part on actions taken with preceding elements.

18. The network element of claim 15, wherein the plurality of paths and actions include superfluous actions.

19. The network element of claim 15, wherein the one or more graphical images includes one or more advertisements.

20. The network element of claim 15, wherein the graphical images comprises geographical maps.
